(19) United States
(12) Patent Application Publication
(10) Pub. No.: US 2007/0219937 A1
(43) Pub. Date: Sep. 20, 2007

(54) AUTOMATED VISUALIZATION FOR ENHANCED MUSIC PLAYBACK

(75) Inventors: Michael Lee, Palo Alto, CA (US); Mark Dolson, Ben Lomond, CA (US); Jean-Michel Trivi, Boulder Creek, CA (US)

Correspondence Address: SCHWEGMAN, LUNDBERG, WOESSNER & KLUTH/CREATIVELABS, P.O. BOX 2938, MINNEAPOLIS, MN, 55402, US

(73) Assignee: CREATIVE TECHNOLOGY LTD, SINGAPORE (SG)

(21) Appl. No.: 11/619,011

(22) Filed: Jan. 2, 2007

Related U.S. Application Data
(60) Provisional application No. 60/755,835, filed on Jan. 3, 2006.

(51) Int. Cl. G06F 17/30

(52) U.S. Cl. 707/1

(57) ABSTRACT

A method and device for providing visualizations on a media player is described. The method may comprise monitoring playback of an audio stream on the media player selecting visualization data stored on the media player. The visualization data may be previously rendered and including at least one element derived from an audio stream. Thereafter, the selected visualization data is displayed and the audio stream is rendered on the media player. For example, the selected visualization data may be automatically without human intervention rendered in synchrony with the audio stream. The media player may be a portable media player and the visualization data may comprise dynamic element(s) and static element(s). The method may update the dynamic element(s) based on an update algorithm.

### RELATED APPLICATION

The present patent application claims the priority benefit of the filing date of U.S. Provisional Application Ser. No. 60/755,835 filed Jan. 3, 2006, the entire content of which is incorporated herein by reference.

### FIELD

This application relates to a method and system to display pre-rendered visualizations on a media player.

### BACKGROUND

Media players have the ability to store and play both movies and music. Movie playback typically provides the user with synchronized visual and auditory input from a single movie file (e.g., an MPEG), whereas music playback provides purely auditory input from a single audio file. Technology currently exists for automatically generating visual experiences in real-time on desk top computers by analyzing the underlying audio signal and using the results of this analysis to dynamically generate appropriate visual content for display on a display screen of the computer. However, this technology is too computation-intensive to be readily incorporated into all media players, especially portable media players. There is therefore a need for a less computationally demanding means of automatically augmenting music playback with an aesthetically satisfying visual experience.

### SUMMARY

According to an aspect of the invention there is provided a method and device to automatically provide visualizations to accompany reproduction of an audio stream represented by audio data.

Other features of the present invention will be apparent from the accompanying drawings and from the detailed description that follows.

### BRIEF DESCRIPTION OF DRAWINGS

The present invention is illustrated by way of example, and not limitation, in the figures of the accompanying drawings, in which like references indicate similar elements and in which:

FIG. 1 shows a system, in accordance with an example embodiment, to render visualizations on a media player;

FIG. 2 shows a further example embodiment of a system to render visualizations on a player;

FIG. 3 shows a portable media player in accordance with an example embodiment;

FIG. 4 shows a method, in accordance with an example embodiment, for providing visualizations on a portable media player;

FIG. 5 shows a computing platform, in accordance with an example embodiment, to generate pre-rendered visualizations for subsequent display on a media player;

FIG. 6 shows a method, in accordance with an example embodiment, to transfer pre-rendered visualisations on to a portable media player;

FIG. 7 shows a method, in accordance with an example embodiment, for generating visualizations including dynamic and static elements for storage and subsequent rendering;

FIG. 8 shows visualizations, in accordance with an example embodiment, including dynamic elements and static elements;

FIG. 9 shows method, in accordance with an example embodiment, for updating dynamic elements of a visualization on a portable media player;

FIGS. 10 and 11 show example portable media players having display screens and keypads for user input; and

FIG. 12 shows a diagrammatic representation of machine in the example form of a computer system within which a set of instructions, for causing the machine to perform any one or more of the methodologies discussed herein, may be executed

### DETAILED DESCRIPTION OF EXAMPLE EMBODIMENTS

In the following description, for purposes of explanation, numerous specific details are set forth in order to provide a thorough understanding of example embodiments of the present invention. It will be evident, however, to one skilled in the art that the present invention may be practiced without these specific details.

In an example embodiment, a stored audio stream (including one or more music files stored as audio data) on a media player (e.g., a portable media player/device) is supplemented with one or more suitably customized stored visualization files (which may contain audio as well). An appropriate or selected visualization file is automatically played back (e.g., in synchrony) with a user-specified music/audio stream playback. As the visualizations are pre-rendered on the playback device, this may provide a visual enhancement of the music listening experience without the need for additional graphics or signal processing during music playback. In an example embodiment, stored visualization files may be automatically generated on some other computing platform and downloaded (e.g., transparently) to a portable media player without explicit user intervention. This generation process may optionally employ automated methods for aggregating suitable visual content without user intervention.

In a yet further example embodiment, the stored visualization files may be optionally modified and enhanced during playback by scalable audio-driven video processing so that the resulting user experience is enhanced according to the computational resources available on a specific media player. Synchronous audio and visual effects may be triggered in real-time to further enhance the user experience. For example, visual effects may be tied to spatial aspects of the audio signal. For the purposes of this specification, the term ‘visualization’ is intended to include any graphical display that has at least one element derived from an audio stream. For example, the visualization may be derived from a video clip, or any other graphical information (e.g., geometrical shapes, text, static images, etc.) which has been modified based on intrinsic characteristics of an audio stream.

In an example embodiment, a user of a media player may be provided with a music playback experience equivalent to that which could be obtained via a built-in dynamic music visualizer on a desktop personal computer (PC) that has substantial processing power, yet without the computational expense of actually generating the visualization entirely in real-time on the media player. For example, a defining element of a user experience may be that the user specifies a particular audio stream to be played and automatically becomes the recipient of a corresponding visual stream that is derived from pre-rendered visualization data.

In a yet further embodiment, the visualizations or media objects may include dynamic elements and static elements. The dynamic elements may, for example, be time sensitive elements, which are updated when a defined expiry date is reached. Thus, in an example embodiment, when a media object (e.g., represented by visualization data) requires updating only the dynamic elements need be communicated to a portable media player. As the static elements of the media objects may remain unchanged there may not be a need to modify them and according updating of the media object may be expedited. Examples of dynamic elements include static images, geometric shapes, text, video, audio, resource locators (e.g., Uniform Resource Locator (URL)), media types, activation scripts, expiration dates, display characteristics, or the like.

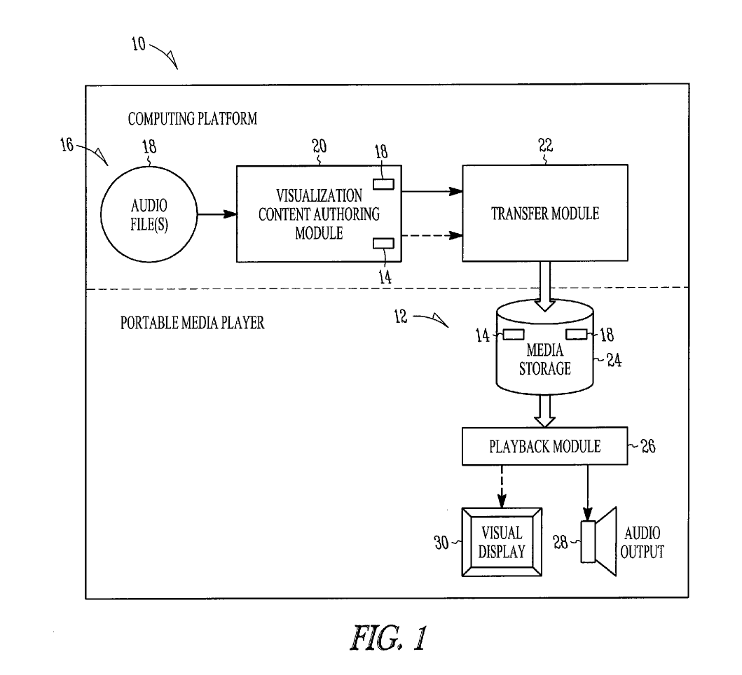

In FIG. 1, reference 10 generally indicates a system, in accordance with an example embodiment, to render visualizations on a media player or device 12. As described in more detail below, customized visualization data or files 14 may be generated on a computing platform 16 and transferred to the portable media player 12. The visualization files 14 may be transferred to the portable media player 12 together with the audio files 18. Thus, as shown in FIG. 1, the computing platform 16 may include a visualization content authoring module 20 and a transfer module 22. For example, the computing platform 16, may use a USB or FireWire connection (or any other connection wireless or wired) to connect to the portable media player 12, thereby to allow the downloading of music files (which may be encoded in any suitable format e.g., MP3 or the like) together with pre-rendered visualizations (e.g., associated pre-rendered visualizations).

The portable media player 12 includes media storage 24, a playback module (or processor) 26, an audio output 28 (e.g., an audio output jack) and a visual display or screen 30. The system 10 allows the selection of a music playback stream (e.g., a music track) and may automatically trigger selection and playback of an appropriate video stream or visualization. It will be noted that in an example embodiment the visualization file 14 and the audio file 18 are stored as separate files on both the computing platform 16 and the portable media player 12. In an example embodiment, the system 10 provides a pre-association of music streams with separately stored and pre-rendered visualizations. Modules, as describes herein, are intended to include conceptual modules, which may correspond to a functional task performed by the portable media player 12.

In an example embodiment, the system 10 may create a parallel table of contents for music files and associated visualization files such that, selecting a given music file for playback, also launches a corresponding visualization file for display on the visual display 30. Further, although example embodiments are described with reference to a portable media player, it is to be noted that the invention is not restricted to portable media players and may be deployed in any media player (e.g., cellular telephone or the like). It will also be appreciated that the methods described herein may be deployed in any music player or device with the ability to display a pre-rendered visualization or video file. It should be noted that the term ‘audio’ is intended to include pre-stored audio tracks as well as audio streams (e.g., radio streams including Internet radio streams). In an example embodiment, pre-designated visual transition points may be dynamically synchronized to intrinsic audio characteristics such as metrical markers detected in real-time from an audio signal.

In the example system 10 there may be a one-to-one correspondence between stored music files and stored visualization files. However, in other embodiments, multiple pre-rendered visualizations for a given music file may be stored. Thus, each time when the given music file is subsequently played, multiple independent accompanying visualizations (or combinations thereof) may be rendered/displayed on the media player. Conversely, in another embodiment, one or more of the pre-rendered visualization files on the portable media player may be selected to accompany playback of a music file when the selected music file lacks a specific associated stored pre-rendered visualization.

In the example system 10, the audio file 18 is shown to be passed through a content authoring process performed by the visualization content authoring module 20. In an example embodiment, the authoring process produces a set of associated, pre-rendered visualization files, which are then stored on the computing platform 16 and subsequently transferred to the portable media player 12. This authoring process may allow for user interaction to apply effects to either the audio or visualization components (or both). Thus, a graphical user interface (GUI) may be provided to allow user input. In an example embodiment, user input may be received to steer a camera, select different views in a game, select different video effects, or the like.

In the example system 10 the output of the authoring process is shown to be both an audio file and a set of visualization files (which may contain audio). Upon playback of an audio file on the media player 12, the playback process or application on the media player 12 can determine the existence of one or more preferred visualization files and proceed to render the preferred set of visualization files synchronously with the audio file. In it will also be appreciated that, in example embodiments, the visualization file (or files) and the audio file may be combined into a single file entity.

The visualization files 14 may include any number of elements, in addition to raw video, that can be used by the playback process to render a visualization component. Note that a given playback process on a portable media player need not be able to make use of all of these elements in which case, only a subset of the elements may actually be consumed for playback (in some cases, the player may be incapable of processing some of the elements). Elements may be used for initialization or real-time control parameters.

A visualization file may, for example, include one or more of the following elements:
video object descriptors
   video clips (with or without audio)
   2D or 3D elements and their relative locations
   camera location, paths and constraints, or lens properties
image object descriptors
   URL (local or remote location)
   Scene or video object target
   Display resolution for the visualization
text descriptors
   informational text descriptors (news items, birthdays, or any other text (with or without audio)
   2D or 3D elements and their relative locations
global video playback parameters
   target frame rate for display of the visualization
   target resolution
   number of frames to display
audio parameters
   equalizer settings
   pre-processing history of the audio signal
   preferred speaker setting for rendering the audio output
time stamped events for real-time triggering of visual and/or audio control
   start/stop visualization clips
   start/stop audio effects (and effect parameters)
   start/stop video effects (and effect parameters)
   continuous control data for audio and/or visualization parameters automatically derived from the audio stream

In an example embodiment, the content authoring process performed by the visualization content authoring module 20 may automatically search for and incorporate pre-existing imagery that is likely to be appropriate for generating visualizations for a particular music steam being processed. For example, album art which has been already stored in a known location on the computing platform 16, or which has been automatically located and downloaded from the Internet, can be used as raw material for the automated generation and pre-rendering of suitable visualizations. Thus, the visual data may be pre-processed by the visualization content authoring module 20 and (subsequently) transferred to the portable media player 12 for subsequent rendering of a visualization that accompanies the playback of an associated audio stream.

In an example embodiment, the entire process of producing a pre-rendered visualization file can be automated and hidden from the end-user so that the end-user's music-playback experience is as if the visualization were being generated on-the-fly, with no prior contemplation or any deliberate preparation on the part of the user. Thus, the visualization file may be generated automatically without human intervention. This can be accomplished, for example, by invisibly embedding the visualization pre-rendering in the process by which music is transferred from the computing platform 16 to the media player 12. For example, a hidden tag may be provided to tell the media player 12 which visualization file(s) are appropriate for which music file(s).

Portable media players may be resourced constrained by Central Processing Unit (CPU) power, memory, mass storage, battery life, and along with other factors. Thus, as a tradeoff is usually involved, the visualization experience can be affected in several ways, such as, less (or no) interactivity due to lack of CPU capabilities, fewer visualizations available due to lack of device storage space, or reduced entertainment time due to lack of battery life to name a few.

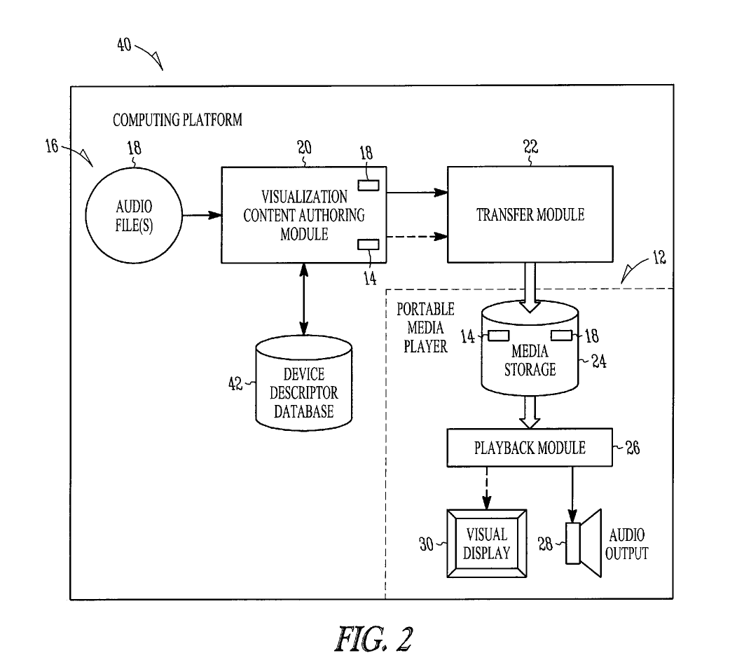

Referring to FIG. 2, reference 40 generally indicates a further example embodiment of a system to render visualizations on a playback device 12. The system 40 resembles the system 10 and, accordingly, like the reference numerals are used to indicate the same or similar features. In particular, the system 40 includes a device descriptor database 42, which stores media player or device capability details. Thus, the computing platform 16, may access the device descriptor database 42 to obtain information on the capabilities of the portable media player 12. Accordingly, the visualization file 14 may be customized for a particular media player 12, which is to display the pre-rendered visualization 14. For example, the device descriptor database 42 may include data on CPU usage and capabilities, storage available on the portable media player 12, information on the visual display 30 provided on the portable media player 12, or the like.

In an example embodiment, interactivity including real-time control of the playback process is provided. Enabling advanced real-time response may consume CPU cycles as the underlying process should be in a relatively constant state of being ready to accept commands from the user.

In certain circumstances, it may be more efficient for the media player to simply omit a device capability provided in the visualization file 14. In such an example case, the visualization files, and the nature of these files, produced for a particular media player can be modified upon production using data in the device descriptor database 42 thereby to enhance CPU usage, battery life, and storage, or the like. By knowing capabilities of the target playback device (either communicated automatically by the media player or specified in a manner by the user), the resulting set of pre-generated visualization files 14 may be modified along the following example dimensions:
visualization objects
   visualization clips
      existence of any visualization clips
      resolution of the visualization
      bit depth of the visualization
      frame rate to display the visualization
      associated audio sample rate
      clip length
   2D and 3D objects
      existence of any objects
      number of vertices
      shading algorithm data
audio parameters
   real-time processing
      on/off

In an example embodiment, interactivity can be scaled by not rendering those aspects which are to remain interactive during the finalization of the audio and visualization elements prior to transfer of the visualization file 14 from the computing platform 16 to the portable media player 12. For example, it may be desirable to pre-render a 3D scene and leave 2D effects for interactive control on the media player 12 itself.

It will be appreciated that, utilizing data in the device descriptor database 42 a user may also have the ability to enjoy a consistent (and potentially identical) visualization experience across a number of media playback platforms with varying capabilities. As mentioned above, although the embodiments that are shown by way of example relate to a portable media player, the example embodiments are not restricted to deployment in a portable device. Thus, in example embodiments the methods and devices described herein are deployed in desktop PCs or the like.

Content for visualizations may be aggregated automatically and transferred to the portable media player 12 in an optionally transparent manner. The visualization associated with a particular audio stream (for example, streamed audio or stored audio files, such as MP3 files) may be automatically triggered when a user selects an associated MP3 file for playback.

It will also be appreciated that the pre-rendered visualizations may be authored or modified on both the computing platform 16, and/or on the portable media player 12. For example, a basic pre-rendered visualization file 14 may be authored on the computing platform 16, and subsequently transferred to the portable media player 12, which then, modifies the pre-rendered visualization at playback. For example, at playback, spatial effects of the pre-rendered visualization may be modified automatically based on characteristics of the audio, user input, or the like.

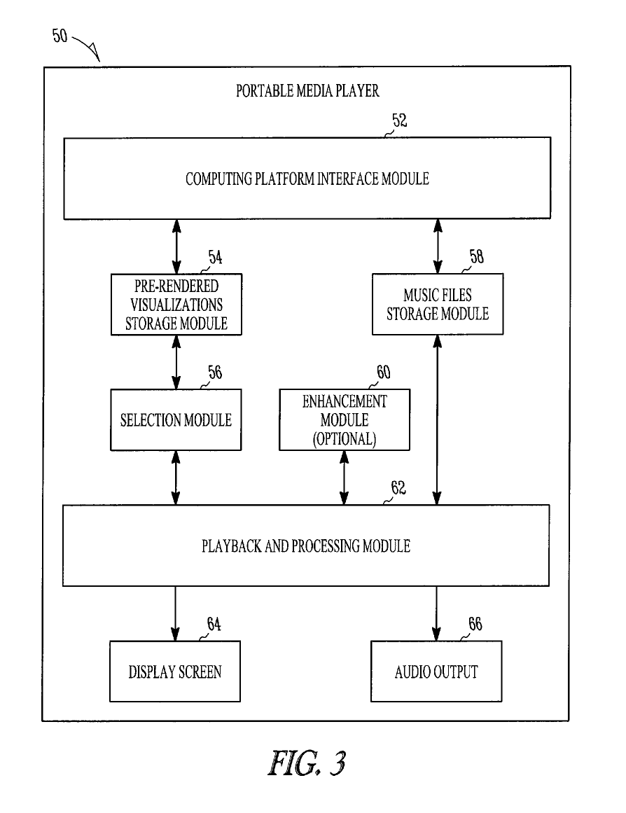

Referring to FIG. 3, reference 50 generally indicates a portable media player in accordance with an example embodiment. The media player 50 is shown to include a computing platform interface module 52, a pre-rendered visualizations storage module 54, a selection module 56, a music file storage module 58, an optional visualization enhancement module 60, a playback and processing module 62, a display screen 64, and an audio output 66. It should be noted that any two or more modules may be combined into a single module and that the modules may represent conceptual modules associated with one or more functional tasks.

The computing platform interface module 52 may interface the portable media player 50 to a computing platform, such as the computing platform 16 herein described. For example, the computing platform interface module 52 may connect the portable media player 50 to the computing platform 16 by a USB connection, a FireWire connection, a wireless connection (e.g., an IP network connection or a mobile telephone network connection), or any other connection that may be used to transfer or communicate visualization files 14 and audio files 18 to the portable media player 50. Although the pre-rendered visualizations 14 and the music files 18 may be stored on a single memory device (e.g., a hard drive, flash memory, or any storage device), the files are shown by way of example to be stored in two separate storage modules for the sake of clarity.

In an example embodiment, when a user connects the portable media player 12 to the computing platform 16, the visualization files 14 and the audio files 18 may be transferred via the computing platform interface module 52. The pre-rendered visualizations 14 may be stored in the storage module 54 and the music files 18 may be stored in the music files the storage module 58. As described in more detail below, when the user selects a particular music file for playback on the portable media player 50, the playback and processing module 62 facilitates the display of the pre-rendered visualizations that accompany the audio output provided to the audio output 66.

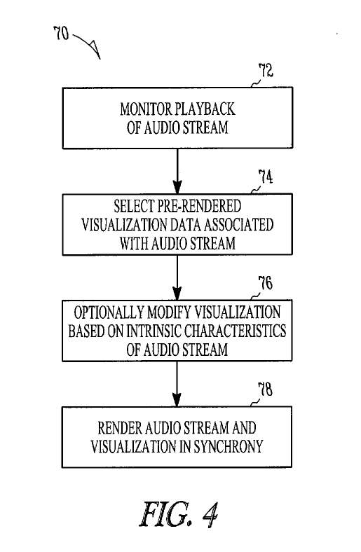

Referring to FIG. 4, reference 70 generally indicates a method, in accordance with an example embodiment, for providing visualizations on a portable media player. For example, the portable media player may be the portable media player 50 as described by way of example hereinbefore. Accordingly, the method 70 is described our way of example with reference to the portable media player 50. A shown at block 72, the method 70 may monitor playback of an audio stream on the portable media player 50. For example, the method 70 may monitor when a user selects one or more audio tracks or audio streams for playback. Thereafter, as shown at block 74, pre-rendered visualization data (e.g., an associated visualization file stored in the pre-rendered visualizations storage module 54) is selected to be processed and accompany the playback of the selected audio file. In an example embodiment, the selected visualization file undergoes minimal processing and is merely used to generate a visualization on the display screen 64. However, in other embodiments, the visualization data or visualization file 14 may be processed on-the-fly to generate a modified visualization on the display screen 64. For example, the pre-rendered visualization file may be modified or processed, based on intrinsic characteristics of the audio stream (see block 76).

Any number of properties from the audio stream can be extracted through analysis and used as visualization control sources. Spectral, temporal, and spatial examples include:
Instantaneous overall signal energy
Instantaneous energy of decorrelated signal
Instantaneous spectral tilt
Instantaneous energy in a particular frequency band
Instantaneous energy in a frequency band and spatial location in the listening field
Instantaneous tempo estimate
Beat markings
   Musical segment markings

Information from these analyses can be used to simultaneously trigger a visualization effect and supply the effect with initialization and a stream of control parameters. In an example embodiment, a lens effect that performs a 2D deformation (spatial or chromatic), whose deformation amount is determined by the overall signal energy, can be triggered by a beat marker resulting in a visual effect that is highly correlated with the audio stream in both time and activity level. In an example embodiment, a method of driving a computer generated animation, as described in U.S. Pat. No. 6,369,822, may be used to generate the pre-rendered visualizations and the contents of U.S. Pat. No. 6,369,822 is incorporated herein by reference.

As shown at block 78, the visualization may be displayed on the display screen 64 and the audio stream, may be output to the audio output 66 (which, for example, may be connected to an earphone or any other transducer for playback to the user).

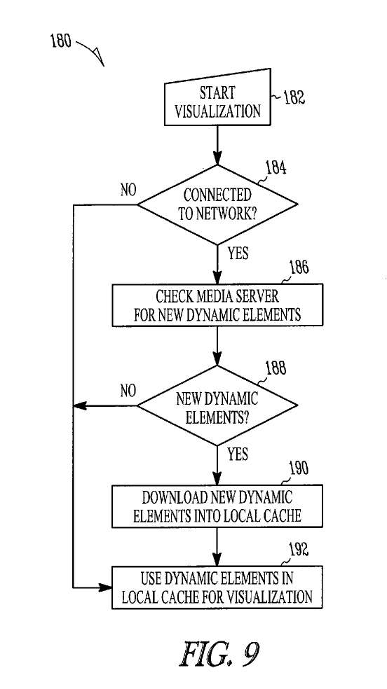

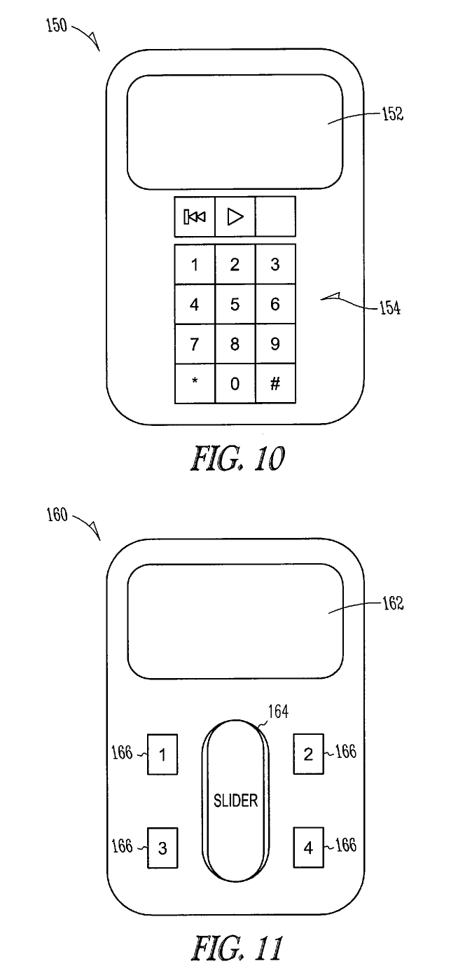

Depending on the computational resources on a target media player, a number of real-time modifications can be enabled. Note that on a portable device with limited interface capabilities, these modifications may be limited to the triggering of such effects. For example, in an interaction model embodiment, a user may choose to put the media player in an interactive mode thus reassigning existing interface elements (such as buttons or touchpad controls) for the purpose of triggering and controlling effects (see FIGS. 9 and 10). In an embodiment, the mapping of effects to interface elements may be assigned ahead of time and can be customized by the user on a per-visualization basis.

FIG. 10 shows an example portable media player 150 including a display 152 and a keypad 154 that can be used to trigger (and/or modify) visualization effects. FIG. 11 shows an example embodiment of a portable media player 160 including a display 162 and a slider element 164 is implemented using a touch sensitive component. In this example configuration, the slider element 164 can be used to recognize a simple gesture or user input that simultaneously initiates an effect trigger event and, optionally, specifies a control parameter as determined by the spatial location of the user touch point. Further operational keys 166 may also be provided to control or modify the visualizations. In an example embodiment, the graphical user interface allows a user to define manually input modification data and the visualization data may be modified based on the manually input modification data.

In an example embodiment, the methods described herein include monitoring selection of the music file by a user, the music file being one of a plurality of music files stored on the media player. Thereafter, the music file may be decoded for playback via at least one speaker and visualization data in the form of a visualization file may be selected from a plurality of visualization files stored as separate files on the media player. The selected visualization file and the music file may then be output on the media player.

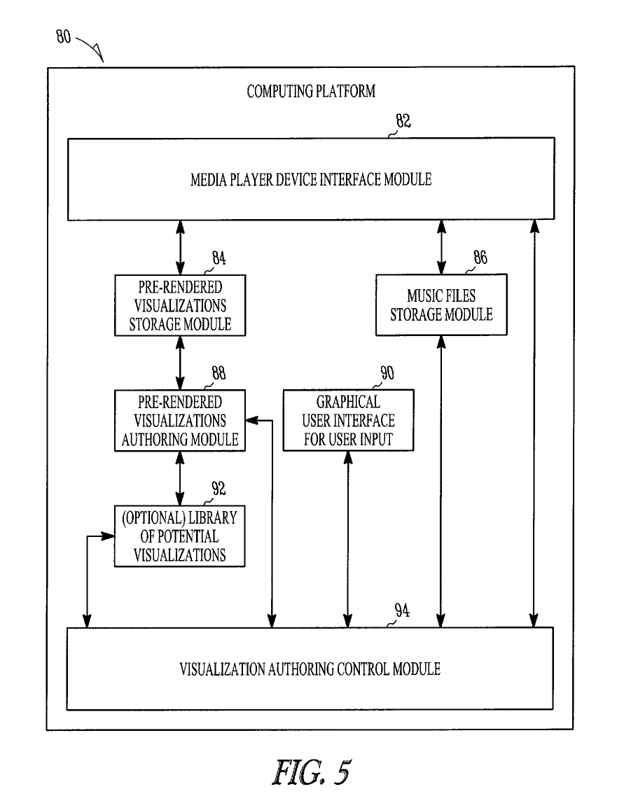

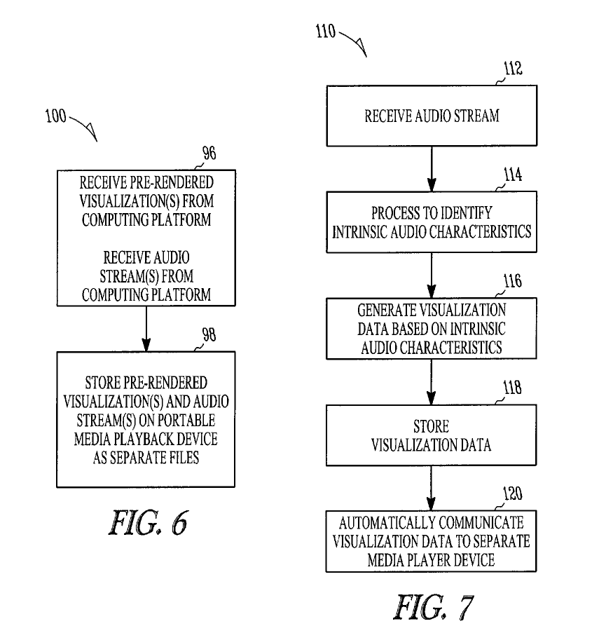

FIG. 5 shows an example computing platform 80 to generate pre-rendered visualizations for subsequent communication to and display on a media player, for example, the portable media player 50. The computing platform 80 is shown to include a media player device interface module 82, a pre-rendered visualizations storage module 84, a music files storage module 86, a pre-rendered visualizations authoring module 88, a graphical user interface (GUI) 90, an optional library of potential visualizations 92, and a visualization authoring control module 94. In use, as described below by way of example, the computing platform 80 may in an automated fashion without human intervention generate one or more customised visualizations that may be stored on the computing platform 80. The customized visualizations may be subsequently communicated (e.g. downloaded) to the portable media player 50 when music files or music streams are downloaded onto the portable media player 50. The pre-rendered visualizations from the computing platform 16, and the audio streams from the computing platform, may then be stored on the portable media player 50 (as shown at blocks 96 and 98 of a method 100 shown in FIG. 6).

In FIG. 7, a method 110 in accordance with an example embodiment for generating visualizations is shown. At block 112 the method 110 receives an audio stream for which a customised visualization is to be generated. It will be appreciated that the audio stream may be a stored audio file on a computing platform (e.g., the computing platform 80), streamed audio from a radio station (e.g., an Internet radio station) or the like, or any other source of audio. Thereafter, as shown at block 114, the audio stream may be processed to identify intrinsic audio characteristics, which are then used to generate visualization data (see block 116). The visualization generated is then stored (see block 118) on the computing platform 80 in, for example, the pre-rendered visualization storage module 84. As in the case of the storage or memory on the portable media player 50, the pre-rendered visualization storage module 84 and the music files storage module 86 may be provided in a single storage medium (e.g., a hard drive of a personal computer that may host the computing platform 80). When the portable media player 50 is coupled to the computing platform 80, and the audio streams or files 18 are transferred to the portable media player 50, the visualization data or files 14 may be transferred together with the audio files in an automated manner (see block 120). Thus, in an example embodiment, a user need not be aware of the automated generation and transfer of the visualization files associated with the audio data.

In an example embodiment, the computing platform 80 includes the graphical user interface 90 that allows a user to further customize a visualization prior to it being transferred to the portable media player 50.

Examples of prior modifications may include the following:
Specification of camera location and paths
Selection of visualization elements and specification of their dimensions and spatial relationships
Specification of lighting models and lighting positions
Selection of image and video media to be used to texture visualization elements
Specification of audio-derived control signal routing and deformation targets
Inclusion of manually entered time-stamped triggering events of visualization effects
Assignment of visualization functions to target device interface elements
Addition of arbitrary graphical text annotations such as lyrics

Once the visualization is on the media player, the following further non real-time modifications may be made:
Designation of a visualization file as a preferred file for a specific audio track
Re-assignment of visualization functions to target device interface elements
Limited editing of time-stamped visualization triggering events

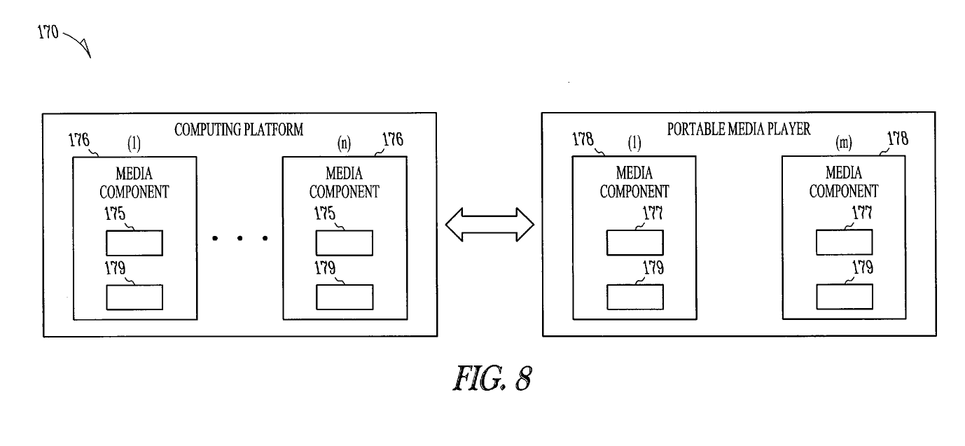

FIG. 8, shows an example system 170 comprising a computing platform 172 (e.g., media server) in communication with a portable media player 174. The computing platform 172 includes a plurality of media components defined by visualization data 176 including one or more dynamic elements 175 (dynamic element data) and one or more static elements 179 (static element data). The dynamic and static elements 175, 179 may be communicated to (e.g., using a synchronization mechanism) to the portable media player 174 where they are stored as corresponding dynamic elements 177 and static elements 179. The term “static element” does not necessarily imply that the elements remain unchanged but rather to indicate that their lifespan in longer (e.g., substantially longer) than that of the dynamic elements 177. Thus, in an example embodiment, the static elements 179 may also be replaced or updated (e.g., the entire media components may be deleted or changed). As described in more detail herein, a dynamic element 175 may be updated based on an update algorithm which, for example, may be dependent upon a date or time associated with the dynamic element 175, locale parameters, or audio track metadata. Thus, in an example embodiment updating visualization data for a visualization on the portable media player 174 may be facilitated as only the dynamic elements 175 may be updated as opposed to the entire visualization. Examples of dynamic element visualization data include a static image element, a geometric shape element, a text element, a video element, an audio element, a resource locator element, a media type element, an activation script element, an expiration date element, or display characteristic element.

As described below, a method in accordance with an example embodiment may identify when the media player 174 is in communication with the computing platform 172, identify at least one cached dynamic element 177 on the portable media player 174 requiring updating, receive at least one updated dynamic element 175 from the computing platform, and update the at least one cached dynamic element 177 with the at least one updated dynamic element 175. In an example embodiment, a user interface (see FIGS. 10 and 11) may be provided to receive a user input associated with updating cached dynamic element(s) 175 and the cached dynamic element(s) 177 may be updated based on the user input. For example, updated dynamic elements 175 may be received from the computing platform 172 (e.g., which mat correspond to the computing platform 80 shown in FIG. 5). The dynamic elements 175 may be received via a wireless communication network (e.g., an Internet Protocol network such as the Internet, a mobile telephony network, or the like) or a wired network connection (e.g., a USB or Fire Wire connection to a personal computer). It should however be noted that an entire visualization or media object may also be updated. Updated dynamic elements may be exchanged in a ‘push’ or ‘pull’ manner.

In an example embodiment, a method and device is provided for dynamically delivering media components to interactive music visualizations running on portable media players to enhance the relevance and interactivity of visualization while conserving update bandwidth and power consumption. Unlike pre-rendered movies, interactive music visualizations may represent a live content format that enables users to enjoy a real-time interactive visualization experience. Advanced music visualizations can incorporate media components such as static images, text, or video elements that contain time-sensitive information. Examples of relevant media components or objects include updated or recent artist images, video snippets, and text messaging. Such components can be made network aware enabling them to update themselves as new content is made available. The new content may be provided in dynamic elements 175, 177 that are updated by connection to the computing platform 172 via a direct or network connection.

On a portable platform such as a portable media player 174, the size of the update can affect the users experience either because of the time required to perform the transfer, the network cost of the transfer (e.g., in cellular telephone networks), or indirectly because of reduced battery life due the need to run wireless components for greater lengths of time. Thus, in an example embodiment, a method is provided that may allow selective dynamic refresh or updating of dynamic elements of media components in real-time, for example, as the visualization is being consumed. This may provide the user the benefit of receiving fresh and timely content thereby enhancing the richness and novelty of the visualization.

In an example embodiment, advanced music visualizations or components are provided that may include any number of media elements, such as static images, geometric shapes, and text elements. As mentioned above, one or more of these elements may be dynamic in that they may change over time where the changes may be correlated to some aspect of the audio stream.

FIG. 9 shows a method 180, in accordance with an example embodiment, for updating dynamic elements of a visualization on a portable media player. The method 180 may be performed on the portable media player 174 (which may correspond to the portable media player 50 shown in FIG. 3) and, accordingly, is described by way of example with reference thereto.

As shown at block 182 when a visualization starts on the portable media player 174, the portable media player 174 may first determine (see decision block 184) if it is connected to the computing platform 172 (e.g., a media server). As mentioned herein, the connection may be wired or wireless. If the portable media player 174 is connected to the computing platform 172, then for each dynamic (or modifiable) element 177 used in generating the visualization, a visualization application may check to see if there are new or updated elements (dynamic element(s) 175) on the computing platform 172 for download. If updated elements are available, they may be downloaded to the portable media player 174. The aforementioned functionality is shown in blocks 186-190. A set of available updates can be derived from (but not restricted to) a set of parameters that may originate from the portable media player itself such as geographic location, time and date, audio track metadata, or the like. In an example embodiment, the visualization itself may proceed independently during the query performed at block 186 and any subsequent download process performed at block 190 by using the dynamic elements 177 currently in its local cache (e.g., stored in the pre-rendered visualizations storage module 54 shown by way of example in FIG. 3).

Once downloaded, the local cache can be updated according to any algorithm that may incorporate any number of dynamic element attributes such as an expiration date. As shown at block 192, when rendering the visualization on the portable media player 174, the dynamic elements 177 stored in the local cache or memory are used.

Returning to decision block 184, if the portable media player 174 is not connected to the computing platform 172 (or any source providing dynamic components 177), or if there are no updates available (see decision block 188), the visualization proceeds to use the components already present in its localized cache (see block 182). Note that by incorporating the notion of media components utilizing dynamic elements, a media cache or the portable media player 174, bandwidth may be conserved by only requiring necessary elements to be transmitted.

Example dynamic media elements include:
A text descriptor
A resource location (e.g., a Uniform Resource Locator or URL)
A media type (e.g., a still image, a video clip, audio clip, etc.)
A preferred size of an image or visualization to be displayed on a portable media player
An expiration date where after the element (of any parameters thereof) are no longer valid
An activation script (e.g., a script for execution on the portable media player)

In an example embodiment the activation script may include interpreted instructions for the visualization to execute should an associated media element be activated. For example an activation script may be associated with an image that, when selected (e.g., via the keypad 154 shown in FIG. 10 or the slider element 164/operational keys 166 shown in FIG. 11), takes the user to a website or web service that offers merchandise or services to the end user.

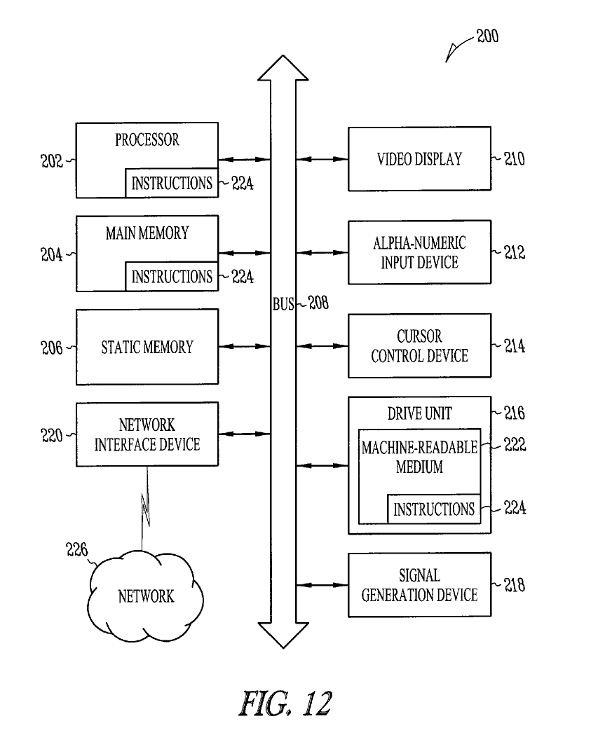

FIG. 12 shows a diagrammatic representation of machine in the example form of a computer system 200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, the portable media player or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 200 includes a processor 202 (e.g., a central processing unit (CPU), a graphics processing unit (GPU), a digital processing unit (DSP)), a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a user interface (UI) navigation device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer system 200, the main memory 204 and the processor 202 also constituting machine-readable media.

The software 224 may further be transmitted or received over a network 226 via the network interface device 220 utilizing any one of a number of well-known transfer protocols (e.g., HTTP).

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method of providing a visualization on a media player, the method comprising:
monitoring playback of a selected audio stream on the media player;
selecting visualization data stored on the media player, the visualization data being previously rendered and including at least one element derived from an audio stream; and
rendering the selected visualization data and the selected audio stream on the media player.

2. The method of claim 1, wherein the media player is a portable media player and the visualization data comprises at least one dynamic element and at least one static element, the method comprising updating the dynamic element based on an update algorithm.

3. The method of claim 2, which comprises updating the at least one dynamic element based on an update algorithm that is dependent upon at least one of a date or time associated with the at least one dynamic element.

4. The method of claim 2, which comprises updating the at least one dynamic element based on locale parameters or audio track metadata.

5. The method of claim 2, wherein the visualization data comprises at least one of a static image element, a geometric shape element, a text element, a video element, an audio element, a resource locator element, a media type element, an activation script element, an expiration date element, or a display characteristic element.

6. The method of claim 2, which comprises:
identifying when the media player is in communication with a computing platform;
identifying at least one cached dynamic element that requires updating;
receiving at least one updated dynamic element from the computing platform; and
updating the at least one cached dynamic element with the at least one updated dynamic element.

7. The method of claim 6, which comprises:
providing a user interface to receive a user input associated with updating the at least one dynamic element; and
updating the at least one cached dynamic element based on the user input.

8. The method of claim 6, which comprises receiving the at least one dynamic element from the computing platform via a wireless communication network.

9. The method of claim 8, wherein the wireless communication network is one of an Internet Protocol network or mobile telephony network.

10. The method of claim 1, which comprises automatically without human intervention rendering the selected visualization data in synchrony with the selected audio stream.

11. The method of claim 1, wherein the media player is a portable media player, the method comprising:
receiving audio data from a computing platform;
receiving associated visualization data from the computing platform; and
storing the visualization data and the audio data as separate files on the portable media player.

12. The method of claim 1, which comprises selectively modifying the visualization rendered on the media player in real-time when the audio stream is rendered from the audio data.

13. The method of claim 12, which comprises modifying elements of the visualization based on the intrinsic characteristics of the audio data.

14. The method of claim 13, in which the elements comprise at least one element selected from the group including a video object descriptor or an image object descriptor.

15. The method of claim 12, which comprises:
receiving a user input on the media player; and
modifying the visualization based on the user input.

16. The method of claim 1, which comprises modifying spatial aspects of the visualization rendered on the media player based on intrinsic characteristics of the audio stream.

17. The method of claim 1, wherein the audio data includes a music file, the method comprising:
monitoring selection of the music file by a user, the music file being one of a plurality of music files stored on the media player;
decoding the music file for playback via at least one speaker;
selecting visualization data in the form of a visualization file selected from a plurality of visualization files stored as separate files on the media player; and
rendering the selected visualization file and the music file on the media player.

18. The method of claim 1, which comprises:
receiving the visualization data and the audio stream as separate files from a separate computing platform; and
storing the visualization data and the audio stream as separate files on the media player.

19. The method of claim 1, which comprises:
identifying a tag associated with the audio stream; and
selecting visualization data identified by the tag.

20. A method of generating pre-rendered visualizations, the method comprising:
receiving audio data representing an audio stream;
processing the audio stream to identify intrinsic audio characteristics of the audio stream;
generating visualization data including at least one element based on the intrinsic audio characteristics;
storing the visualization data to provide pre-rendered visualization data; and
automatically communicating the visualization data to a separate media player when the audio data is communicated to the separate media player.

21. The method of claim 20, which comprises generating visualization data including dynamic and static elements.

22. The method of claim 20, which comprises generating the visualization data automatically without human intervention.

23. The method of claim 20, which comprises:
generating a graphical user interface that allows a user to define manually input modification data; and
modifying the visualization data based on the manually input modification data.

24. The method of claim 20, wherein the visualization data is stored as a separate visualization file for retrieval when the audio stream is rendered.

25. The method of claim 20, which comprises;
automatically without human intervention aggregating visualization content; and
automatically without human intervention generating the visualization data from the visualization content.

26. The method of claim 20, which comprises:
identifying characteristics of a portable media player; and
processing the visualization data dependent upon the characteristics of the portable media player.

27. The method of claim 26, wherein the characteristics of the portable media player include one of storage available on the portable media player or Central Processor Unit (CPU) related parameters.

28. The method of claim 26, wherein the characteristics comprise visual playback capabilities of the portable media player.

29. A media player comprising:
a processing module to monitor playback of an audio stream on the media player;
a memory module to store visualization data;
a selection module to select the visualization data, the visualization data being previously rendered and including at least one element derived from an audio stream; and
a display module to display the visualization data as a visualization,
wherein the processing module processes the selected visualization data and renders the visualization and the audio stream

30. A machine-readable medium embodying instructions which, when executed by a machine, cause the machine to:
monitor playback of an audio stream on a media player;
select visualization data stored on the media player, the visualization data being previously rendered and including at least one element derived from an audio stream;
render the selected visualization data to provide visualizations on the media player; and
render the audio stream on the media player.

31. A machine-readable medium embodying instructions which, when executed by a machine, cause the machine to:
receive audio data representing an audio stream;
process the audio stream to identify intrinsic audio characteristics of the audio stream;
generate visualization data including at least one element based on the intrinsic audio characteristics;
store the visualization data to provide pre-rendered visualization data; and
automatically communicate the visualization data to a separate media player when the audio stream is communicated to the separate media player to provide visualizations on the separate media player.

32. A media player to provide visualizations, the media player comprising:
means for monitoring playback of an audio stream on the media player;
means for selecting visualization data stored on the media player, the visualization data being previously rendered and including at least one element derived from an audio stream; and
means for rendering the selected visualization data and the audio stream on the media player.
